(19) United States
(12) Patent Application Publication
(10) Pub. No.: US 2026/0361061 A1
(43) Pub. Date: Nov. 12, 2026

(54) MECHANICAL HIGH VOLTAGE SAFETY MECHANISM

(71) Applicant: Schaeffler Technologies AG & Co. KG, Herzogenaurach (DE)

(72) Inventors: Matthew Payne, Glenmont, OH (US); Noah Kee, Rittman, OH (US)

(73) Assignee: Schaeffler Technologies AG & Co. KG, Herzogenaurach (DE)

(21) Appl. No.: 19/202,162

(22) Filed: May 8, 2025

(51) Int. Cl. H02G 3/08; H02G 3/14

(52) U.S. Cl. CPC H02G 3/083; H02G 3/14

(57) ABSTRACT

A junction box assembly including a housing having an opening for accessing an interior chamber of the housing, a connector adjacent the opening for connection of a cable, and an access panel mounted to the housing. A slide cover is movable between a first position and a second position, the first position restricting access to the opening of the housing and permitting a cooperating cable to engage the connector adjacent the opening and the second position permitting access to the opening of the housing and restricting a cooperating cable from engaging the connector adjacent the opening. The slide cover can include a feature for covering a restriction access to a fastener securing the access panel the housing when in the first position.

### TECHNICAL FIELD

The present disclosure relates generally to junction box assemblies. More particularly, the present disclosure relates to a junction box assembly having an access panel.

### BACKGROUND

Junction box assemblies are generally well known in electric motor (e-motor) applications. A junction box assembly is generally configured to transfer power from the power electronics unit (PEU) to the e-motor. In a typical configuration, a junction box assembly receives electrical power from a cable connected to the junction box assembly by a connector mounted adjacent or on the junction box assembly.

Some junction box assemblies include a removable access panel for allowing access to an interior of the junction box for repairs. For safety reasons, an interlock switch is typically provided to prevent the flow of current through the junction box assembly when the access panel is removed. Alternatively, some access panels are designed such that they can only be removed following the disconnection of the cable from the connector. Such access panels, however, do not restrict the ability of the cable to be reconnected to the connector before the access panel is reinstalled. Thus, the possibility remains that the junction box could be energized while the access panel is removed.

### SUMMARY

In accordance with one aspect of the present disclosure a junction box assembly comprises a housing having an opening for accessing an interior chamber of the housing containing high-voltage surfaces, an electrical connector adjacent the opening, an access panel mounted to the housing and selectively removable to provide access to the interior chamber of the housing, and a slide cover secured to the housing and restricting access to the at least a portion of the interior chamber of the housing in a closed position and permitting access to the interior chamber of the housing in an open position. The slide cover in the closed position permits a cooperating electrical cable to be connected to the electrical connector and at least partially restricts access to the interior chamber of the housing containing high-voltage surface, and the slide cover in the open position permits access to the interior chamber of the housing and restricts a cooperating high-voltage connector from engaging the high-voltage connector adjacent the opening.

The slide cover can include an upper flange and a lower flange connected to the upper flange by a connecting flange. The lower flange can block access to the electrical connector when the slide cover is moved from the closed position at least partially to the open position. The upper flange can extend through a slot in the housing. A seal element can be provided for sealing the upper flange to the housing in the closed position. The slide cover can include an extension extending from the connecting wall opposite the lower flange. At least one fastener for securing the slide cover to the housing in the closed position can be provided. The lower flange can include a stop for limiting travel of the slide cover at the open position. An insulating cover covering the high-voltage surfaces can be provided.

The access panel can be secured to the housing with at least one fastener, and the slide cover can further include a top flange adapted to restrict removal of the at least one fastener securing the access panel to the housing when in the closed position. The access panel can have a c-shape cross-section. The slide cover can include an upper flange and a lower flange connected to the upper flange by a connecting flange. The upper flange and the lower flange can extend in parallel offset planes. The top flange can extend perpendicular to the connecting flange.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a perspective view of a drive unit with an access panel in an open closed position.

FIG. 2 is a perspective view of the drive unit of FIG. 1 with the access panel in an open position.

FIG. 3 is a plan view of an interior of a junction box assembly.

FIG. 4 is a plan view of another junction box assembly including a slide cover in a closed position in accordance with the present disclosure.

FIG. 5 is a cross-sectional view of the junction box assembly of FIG. 4.

FIG. 6 is a plan view of the junction box assembly of FIGS. 4 and 5 with the slide cover in an open position.

FIG. 7 is a cross-sectional view of the junction box assembly of FIG. 6.

FIG. 8 is a plan view of another junction box assembly including a slide cover in a closed position in accordance with the present disclosure.

FIG. 9 is a side view of the junction box assembly of FIG. 8.

FIG. 10 is a plan view of the junction box assembly of FIGS. 8 and 9 with the slide cover in an open position.

FIG. 11 is a cross-sectional view of the junction box assembly of FIG. 10.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

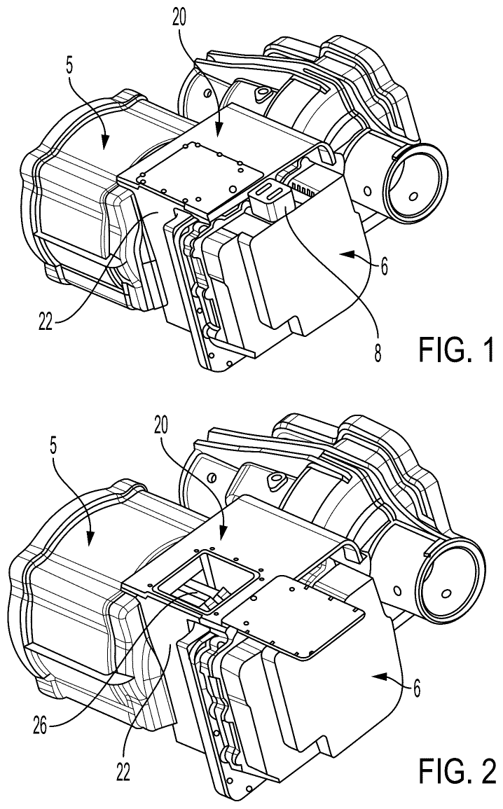

Referring to FIG. 1, an assembly is disclosed that includes an e-motor 5 and a PEU 6. The PEU 6 includes a low-voltage connector 8 adapted to couple with a mating connector 10 of a low-voltage cable (not shown) to receive electrical power. The PEU 6 supplies electrical power to the e-motor 5 via a junction box assembly 20.

The junction box assembly 20 includes a housing 22 enclosing various components such as bus bars 26 and other components for electrically coupling the PEU 6 with the e-motor 5. An access panel 30 is provided for accessing an interior of the housing 22 of the junction box assembly 20. The access panel 30 is selectively movable between a first position closing an opening 34 in the housing 22 and a second position exposing the opening 34 in the housing 22 and covering the low-voltage connector 8. Although not shown, it will be appreciated that a low-voltage cable connected to the low-voltage connecter 8 must first be unplugged before the access panel 30 can be moved from the first position to the second position.

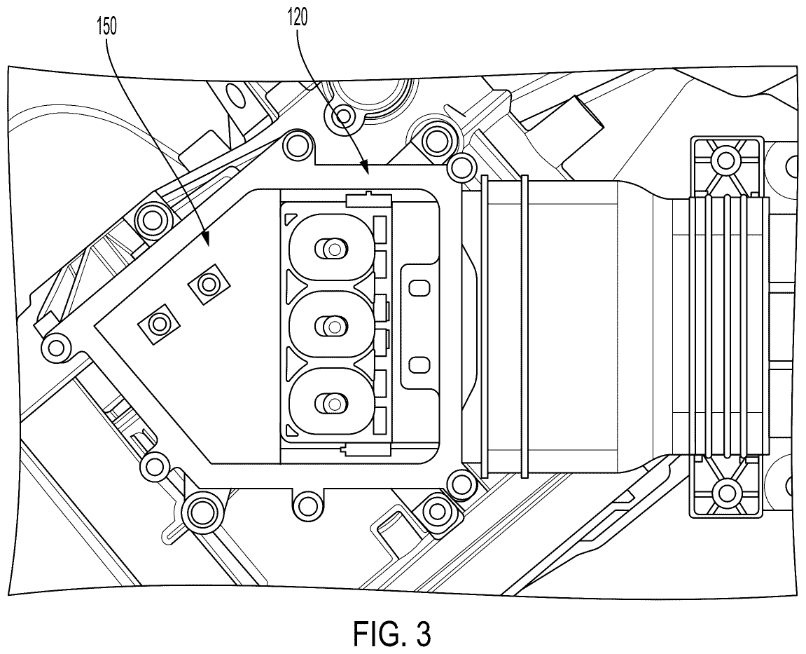

In some applications, additional protection from exposed high-voltage components can be provided. In FIG. 3, for example, a junction box assembly 120 includes an insulated internal cover. The insulated cover 150 in one embodiment includes a plastic cover bolted to the header within the cavity of the junction box assembly 120 covering the high-voltage surfaces. In another embodiment, the high-voltage surfaces within the junction box assembly 120 are overmolded with an insulative material forming the insulated cover 150. In both embodiments, the insulated cover 150 is separate from an access panel (not shown) that must first be removed to expose the cavity of the junction box assembly including the high-voltage surfaces.

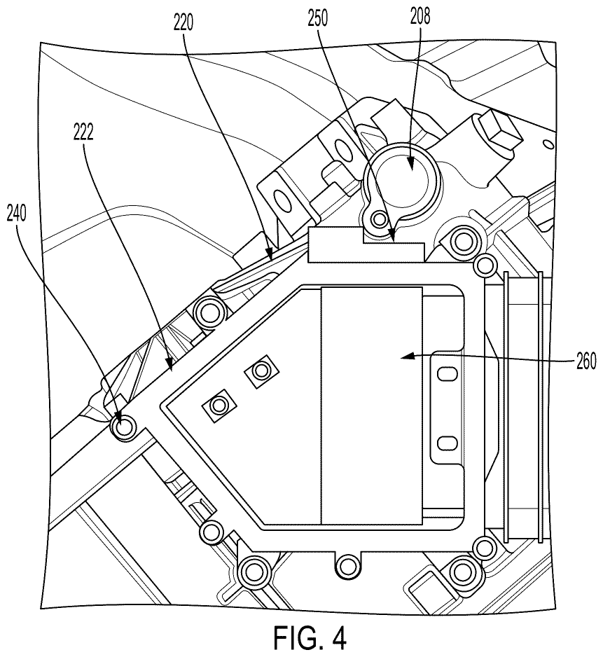

Turning to FIGS. 4-7, an exemplary junction box assembly 220 includes a housing 222 enclosing various components within a chamber 224 such as bus bars 226 and other components for electrically coupling a PEU with an e-motor, for example. An access panel (not shown in this embodiment) is provided for accessing an interior of the housing 222 of the junction box assembly 220. The access panel is secured over an opening of a cavity 238 in the housing 222 with a plurality of fasteners, such as bolts 240. The junction box assembly 220 may be part of a PEU and/or drive unit of a vehicle and includes a low-voltage connector 208 adapted to mate with a low-voltage cable (not shown). A slide cover 250 is secured to the housing 222 of the junction box assembly 220 with a bolt 258.

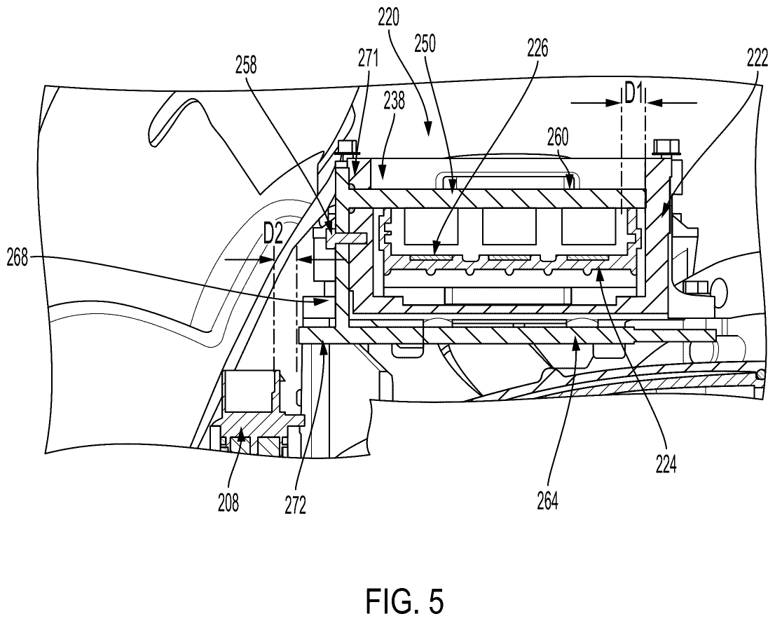

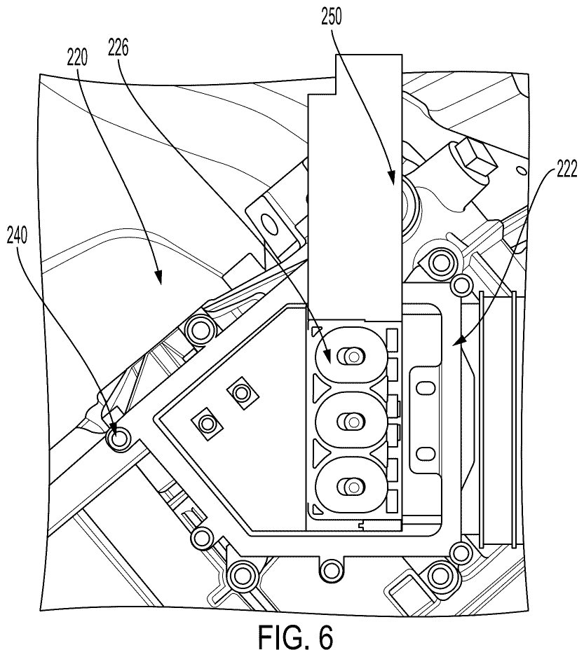

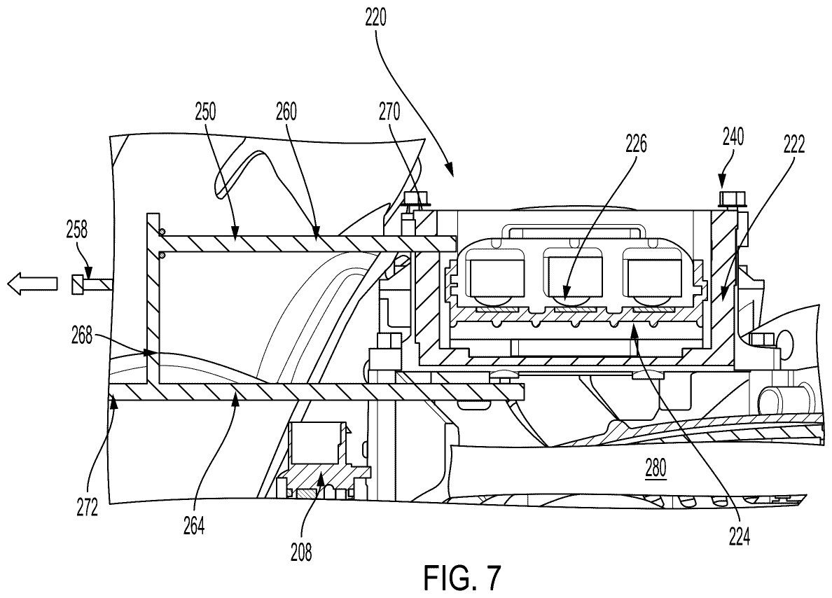

The slide cover 250 has a generally C-shape cross-section including an upper flange 260, a lower flange 264 and a connecting flange 268 extending between the upper flange 260 and the lower flange 264. The upper flange 260 is received in a slot 270 in the housing 222 and is configured to enclose or otherwise restrict access to the high-voltage surfaces within the junction box assembly 220 when in a closed position (FIGS. 4 and 5). A seal element 271 is provided for sealing the slide cover 250 to the housing. Upon removal of the bolt 258, the slide cover 250 can be translated to the left in FIG. 5 to the open position of FIGS. 6 and 7 thereby exposing and/or allowing access to the high-voltage surface within the junction box assembly 220. It will be appreciated that the lower flange 264 is dimensioned such that it covers or otherwise restricts access to the low voltage connector 208 when the slide cover 250 is at least partially translated towards the open position. In this regard, a first distance D1 is greater than a second distance D2 such that access to the low-voltage connector 208 is restricted prior to the upper flange 260 exposing the high-voltage surfaces within the junction box assembly 220 and, when the slide cover 250 is in the open position, access to the low-voltage connector 208 for the purposes of connecting a low-voltage cable thereto is restricted. As such, disconnection of a low-voltage cable from the low-voltage connector 208 is required prior to the slide cover 250 being translated to a position exposing the high-voltage surfaces within the junction box assembly 220 and connection of a low-voltage cable to the low-voltage connector 208 is then restricted when the slide cover 250 is in the open position.

In the illustrated embodiment, the lower flange 264 includes an extension 272 adapted to ensure access to the low-voltage connector 208 is at least partially blocked prior to exposure of the high-voltage surfaces within the junction box assembly 220. A distance D1 is less than a distance D2 such that the low-voltage connector 208 is at least partially blocked prior to exposure of the high-voltage surfaces. The lower flange 264 extends below the housing of the junction box assembly 220 and includes a stop 280 that impinges on adjacent structure to limit travel of the slide cover 250 at the fully open position.

In some applications, a minimum time delay is desired between the unplugging of a low-voltage cable from the low-voltage connector and removal of the access panel and exposure of the high-voltage components of the junction box assembly 20.

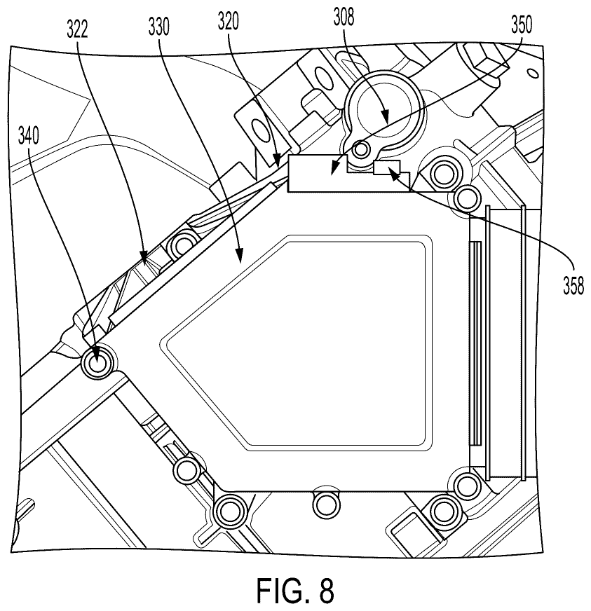

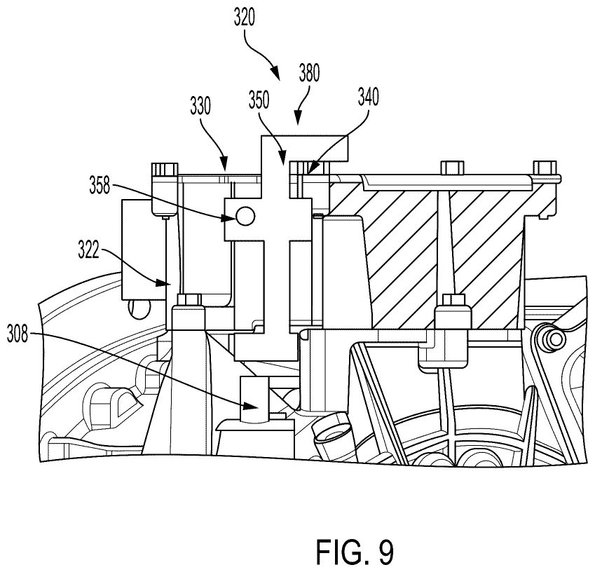

Turning to FIGS. 8 and 9, an exemplary junction box assembly 320 includes a housing 322 enclosing various components within a chamber 324 such as bus bars 326 and other components for electrically coupling a PEU with an e-motor, for example. An access panel 330 is provided for accessing an interior of the housing 322 of the junction box assembly 320. The access panel 330 is secured over an opening in the housing 322 with a plurality of fasteners, such as bolts 340. The junction box assembly 320 may be part of a PEU and/or drive unit of a vehicle and includes a low-voltage connector 308 adapted to mate with a low-voltage cable (not shown). A slide cover 350 is secured to the housing 322 of the junction box assembly 320 with a bolt 358.

The slide cover 350 is similar to the slide cover 250 of FIGS. 4-7 but further includes a feature for restricting access to at least one of the access panel bolts 340. Accordingly, the slide cover 350 has a generally C-shape cross-section including an upper flange 360, a lower flange 364 and a connecting flange 368 extending between the upper flange 360 and the lower flange 364. The upper flange 360 is configured to enclose or otherwise restrict access to the high-voltage surfaces within the junction box assembly 320 when in a closed position (FIGS. 8 and 9). The slide cover 350 includes a top flange 380 that blocks or otherwise restricts removal of an access panel bolt 340 when the slide cover 250 is in the closed position.

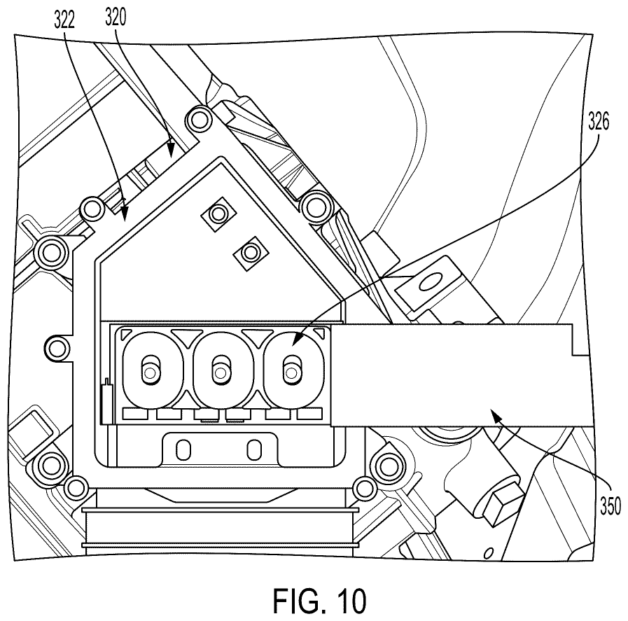

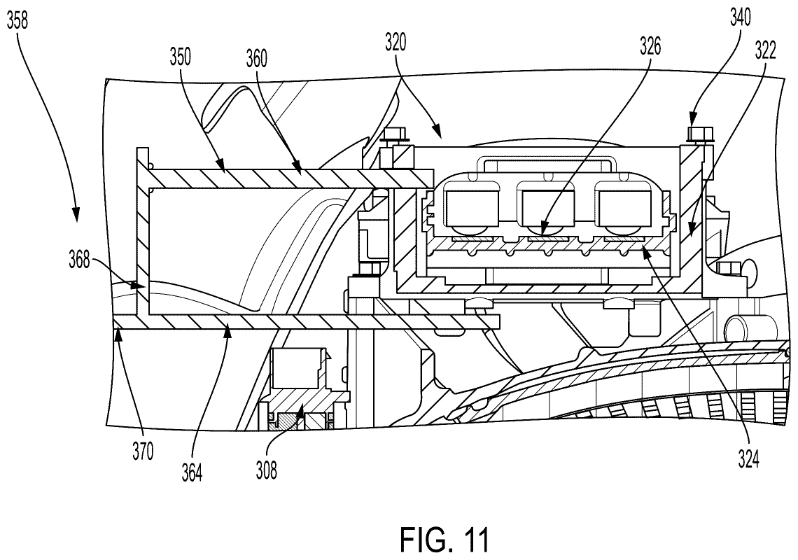

Upon removal of the bolt 358, the slide cover 350 can be translated to an open position as shown in FIGS. 10 and 11 thereby exposing the bolt 350 for removal to allow the removal of the access panel 330. It will be appreciated that the lower flange 364 is dimensioned such that it covers or otherwise restricts access to the low voltage connector 308 when the slide cover 350 is at least partially translated towards the open position. As such, disconnection of a low-voltage cable from the low-voltage connector 308 is required prior to the slide cover 350 being translated to a position exposing the high-voltage surfaces within the junction box assembly 320 and, when the slide cover 350 is in the open position, access to the low-voltage connector 308 for the purposes of connecting a low-voltage cable thereto is restricted, and connection of a low-voltage cable to the low-voltage connector 308 is restricted when the slide cover 350 is in the open position. In the illustrated embodiment, the lower flange 364 includes an extension 370 adapted to ensure access to the low-voltage connector 308 is at least partially blocked prior to exposure of the high-voltage surfaces within the junction box assembly 320.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

5 e-motor
6 power electronics unit (PEU)
8 low-voltage connector
20 junction box assembly
22 housing
26 bus bars
30 access panel
34 opening
120 junction box assembly
150 insulated cover
208 low-voltage connector
220 junction box assembly
222 housing
224 chamber
226 bus bars
238 cavity
240 bolts
250 slide cover
258 bolt
260 upper flange
264 lower flange
268 connecting flange
270 slot
271 seal element
272 extension
280 stop
308 low-voltage connector
320 junction box assembly
322 housing
324 chamber
326 bus bars
330 access panel
338 cavity
340 bolts
350 slide cover
358 bolt
360 upper flange
364 lower flange
368 connecting flange
380 top flange

What is claimed is:

1. A junction box assembly comprising:
a housing having an opening for accessing an interior chamber of the housing containing high-voltage surfaces;
an electrical connector adjacent the opening;
an access panel mounted to the housing and selectively removable to provide access to the interior chamber of the housing; and
a slide cover secured to the housing and restricting access to the at least a portion of the interior chamber of the housing in a closed position and permitting access to the interior chamber of the housing in an open position;
wherein the slide cover in the closed position permits a cooperating electrical cable to be connected to the electrical connector and at least partially restricts access to the interior chamber of the housing containing high-voltage surfaces; and
wherein the slide cover in the open position permits access to the interior chamber of the housing and restricts a cooperating high-voltage connector from engaging the high-voltage connector adjacent the opening.

2. The junction box assembly according to claim 1, wherein the slide cover includes an upper flange and a lower flange connected to the upper flange by a connecting flange.

3. The junction box assembly according to claim 2, wherein the lower flange blocks access to the electrical connector when the slide cover is moved from the closed position at least partially to the open position.

4. The junction box assembly according to claim 2, wherein the upper flange extends through a slot in the housing.

5. The junction box assembly according to claim 4, further comprising a seal element for sealing the upper flange to the housing in the closed position.

6. The junction box assembly according to claim 2, wherein the slide cover includes an extension extending from the connecting wall opposite the lower flange.

7. The junction box assembly according to claim 2, further comprising at least one fastener for securing the slide cover to the housing in the closed position.

8. The junction box assembly according to claim 2, wherein the lower flange includes a stop for limiting travel of the slide cover at the open position.

9. The junction box assembly according to claim 1, further comprising an insulating cover covering the high-voltage surfaces.

10. The junction box assembly according to claim 1, wherein the access panel is secured to the housing with at least one fastener, and wherein the slide cover further includes a top flange adapted to restrict removal of the at least one fastener securing the access panel to the housing when in the closed position.

11. The junction box assembly according to claim 10, wherein the access panel has a c-shape cross-section.

12. The junction box assembly according to claim 11, wherein the slide cover includes an upper flange and a lower flange connected to the upper flange by a connecting flange.

13. The junction box assembly according to claim 12, wherein the upper flange and the lower flange extend in parallel offset planes.

14. The junction box assembly according to claim 13, wherein the top flange extends perpendicular to the connecting flange.
